(19) United States
(12) Patent Application Publication
(10) Pub. No.: US 2017/0364196 A1
(43) Pub. Date: Dec. 21, 2017

(54) Touch Screen Device and Method for Operating Touch Screen Device

(71) Applicant: ZTE CORPORATION, Shenzhen City, Guangdong Province (CN)

(72) Inventors: Shuanshuan WU, Shenzhen (CN); Liujun HU, Shenzhen (CN); Ying LIU, Shenzhen (CN); Xin JIA, Shenzhen (CN)

(21) Appl. No.: 15/520,834

(22) PCT Filed: Mar. 20, 2015
(86) PCT No.: PCT/CN2015/074782

§ 371 Date: Apr. 20, 2017

(30) Foreign Application Priority Data
Oct. 23, 2014 (CN) 201410571234.1

(51) Int. Cl. G06F 3/041; G06F 3/16; G06F 3/0484

(52) U.S. Cl. CPC G06F 3/0416; G06F 3/167; G06F 3/04842

(57) ABSTRACT

A method for operating a touch screen device and a touch screen device are provided. The method includes that: a touch screen device receives a user command, and identifies the user command (100); when the touch screen device identifies the user command as a mode switching command, the touch screen device switches an operation mode (200); herein the operation mode includes a left hand operation mode, a right hand operation mode or a normal mode. Through a predefined or user-defined operation command, the operation mode switching of a touch screen device may be achieved by a single hand, so the key problem of single-handed operation of a touch screen device with a large screen is solved; and the single-handed operation can be really achieved, thereby improving the user experience of a touch screen device with a large screen.

### TECHNICAL FIELD

The present disclosure relates to the technical field of operating a touch screen device, and more particularly to a method for operating a touch screen device and a touch screen device.

### Background

In modern society, mobile phones and other handheld devices become more and more important in people's life, and a touch screen is used more and more widely because of its convenience on operation. More significantly, due to the changes of user requirement and usage habit, the screen of a handheld device becomes larger and larger.

Generally, after the screen size exceeds 4 inches, for such a handheld device with a large screen, when a user holds the handheld device by a single hand, it is hard for him/her to perform a full-range operation on the touch screen by the hand holding the handheld device; and it is difficult to operate a large part of area on the screen of the handheld device;. Due to that, the user has to operate by two hands, that is, one hand holds the device, and the other hand operates the touch screen. But in many cases, for example, when the user is carrying things in hand or holding a handle, the user cannot operate the touch screen by two hands, thereby causing problems for the use of the handheld device.

To solve the problem of operating a large touch screen, there are a part of handheld devices with large screens that can realize special customization of an interface, for example, a control that a user often operates is placed at the bottom of the screen, to be convenient for the user to operate by a single hand. However, on one hand, only a part of problems can be mitigated; on the other hand, a related single-handed operation mode can be started only by entering a setup menu for setting, which greatly limits the application of the single-handed operation mode, and reduces the user experience.

### SUMMARY

The technical problem to be solved by the present disclosure is to provide a touch screen device and a method for operating a touch screen device, to solve the problem of switching an operation mode when a user holds a mobile phone with a large screen by a single hand.

To solve the above technical problem, the following technical solutions are adopted.

A method for operating a touch screen device is provided, which includes that:

a touch screen device receives a user command, and identifies the user command;

when the touch screen device identifies the user command as a mode switching command, the touch screen device switches an operation mode;

herein, the operation mode is a left hand operation mode, a right hand operation mode or a normal mode.

In an exemplary embodiment, the mode switching command includes a set touch operation command and a set voice operation command.

In an exemplary embodiment, the set touch operation command includes:

a touch operation command for setting a touch action, a touch operation command for setting a screen area, or a touch operation command for setting a touch action in a set screen area.

In an exemplary embodiment, the step that when the touch screen device identifies the user command as the mode switching command, the touch screen device switches the operation mode includes:

when the touch screen device identifies the user command as the mode switching command, switching to the next operation mode of a current operation mode; or

when the touch screen device identifies the user command as the mode switching command, switching the current operation mode to an operation mode indicated by the user command; or,

when the touch screen device identifies the user command as the mode switching command, switching the current operation mode to an operation mode selected by a user.

In an exemplary embodiment, after the step that the touch screen device receives the user command, and before the step that the touch screen device identifies the user command, the method further includes:

unlocking the touch screen.

A touch screen device is provided, which includes: an analyzing unit and a switching unit.,

The analyzing unit is configured to receive the user command, and identify the user command.

The switching unit is configured to, when the touch screen device identifies the user command as the mode switching command, switch the operation mode.

Herein, the operation mode is a left hand operation mode, a right hand operation mode or a normal mode.

In an exemplary embodiment, the mode switching command includes a set touch operation command and a set voice operation command.

In an exemplary embodiment, the set touch operation command includes: a touch operation command for setting a touch action, the touch operation command for setting a screen area, or the touch operation command for setting a touch action in the set screen area.

In an exemplary embodiment, the switching unit is configured to switch the operation mode in the following way:

switching to the next operation mode of a current operation mode; or

switching the current operation mode to the operation mode indicated by the user command; or,

switching the current operation mode to the operation mode selected by the user.

In an exemplary embodiment, the device further includes an unlocking unit.

The unlocking unit is configured to, after the analyzing unit receives the user command, unlock the touch screen, and after unlocking is completed, inform the analyzing unit to identify the user command.

A terminal is provided, which includes the above touch screen device.

A computer program is provided, which includes a program command; when the program command is executed by the terminal, the terminal can perform the method for operating a touch screen device.

A carrier is provided, which carriers the computer program.

According to the technical solutions of the present disclosure, through a predefined or user-defined operation command, the operation mode switching of a touch screen device may be achieved by a single hand, so the key problem of single-handed operation of a touch screen device with a large screen is solved and the single-handed operation can be really achieved, thereby improving the user experience of a touch screen device with a large screen.

### BRIEF DESCRIPTION OF DRAWINGS

FIG. 1 is a flowchart of a method for operating a touch screen device according to an embodiment of the present disclosure.

FIG. 2(a) is a switching diagram of a defined touch action that is easiest to be carried out during holding by the left hand, to trigger an operation mode of a touch screen device according to an embodiment of the present disclosure.

FIG. 2(b) is a switching diagram of a defined touch action that is easiest to be carried out during holding by the right hand, to trigger an operation mode of a touch screen device according to an embodiment of the present disclosure.

FIG. 3(a) is a schematic diagram of an area that can be touched to operate when a touch screen mobile phone is held by the left hand according to an embodiment of the present disclosure.

FIG. 3(b) is a schematic diagram of an area that can be touched to operate when a touch screen mobile phone is held by the right hand according to an embodiment of the present disclosure.

FIG. 4 is a schematic diagram of a locking screen interface which is suitable for operation mode switching by taking long-press the screen to unlock as an example according to an embodiment of the present disclosure.

FIG. 5 is a schematic diagram that a character input keyboard or a pattern unlocking area slides to the lower right corner to enter a right hand operation mode according to an embodiment of the present disclosure.

FIG. 6 is a structure diagram of a touch screen device according to an embodiment of the present disclosure.

### DETAILED DESCRIPTION

The technology solution of the present disclosure is elaborated below in combination with the accompanying drawings. Note that, the embodiments in the application and the features in the embodiments can be randomly combined with each other on the condition of no conflict.

### Embodiment One

The present embodiment provides a method for operating a touch screen device. As shown in FIG. 1, the method at least includes the following steps:

In step 100, a touch screen device receives a user command, and identifies the user command.

In step 200, when the touch screen device identifies the user command as a mode switching command, the touch screen device switches an operation mode.

Herein, the operation mode is a left hand operation mode, a right hand operation mode or a normal mode.

In the present embodiment, the left/right hand operation mode involved means that the mode by which operation on the touch screen device can be completed only by the left hand or the right hand; for example, although the screen of the touch screen device is large (like a touch screen mobile phone with a 5 inches or larger screen), when the user holds the mobile phone with a single hand, it is still possible to operate the mobile phone by the hand holding the mobile phone. The normal mode is a usual mode of operating the touch screen device, for example, the operation on the mobile phone is achieved usually by two hands.

In the above method, the user command may be a user input to operate the touch screen device. The mode switching command is a command for triggering the switching of the operation mode. The mode switching command may be preconfigured or pre-set by the user.

Specifically, the mode switching command includes a set touch operation command and a set voice operation command.

First of all, a solution of configuring the set voice operation command as the mode switching command is introduced, that is, the mode switching command is a voice command. The touch screen device receives, through a microphone, a voice command (namely the user command) and identifies the voice command; and when the identified voice command is the set mode switching command, operation mode switching is started.

For example, there is a predefined voice command (namely a predefined mode switching command) in the touch screen device; when the received voice command (namely the user command) matches with the predefined voice command, the operation mode switching is started. The voice command may be ‘left hand mode’, ‘right hand mode’, ‘left hand’, ‘right hand’, ‘usual (normal)’, ‘single hand’, and so on.

Or, the voice command may be defined by the user (namely the mode switching command predefined by the user); when the received voice command (namely the user command) matches with the defined voice command, the operation mode switching is started. For example, the user can record, through the microphone, the defined voice command in an interface for setting; then the touch screen device receives and stores the voice command.

In practical applications, the touch screen device may turn on a voice command collecting switch to collect or identify the voice command only after voice command collecting is triggered. The way of turning on a triggering switch may a specific operation on the touch screen device, like pressing the screen, or pressing on a certain key (a physical key or a virtual key) on the touch screen device or the like.

In an exemplary embodiment, the voice command collecting switch may also be turned off in a timing mode, that is, the voice command collecting switch is turned off after a predefined period of time, or after finishing the specific operation, like stopping pressing the screen, or stopping pressing a certain key on the touch screen device or the like.

Secondly, a solution of configuring the set touch operation command as the mode switching command is introduced. Specifically, the touch operation command may also include various operations.

For example, the touch operation command is the operation command for setting a touch action, including but not limited to: sliding with a predefined track, continuous multi-click (the multi-click is more than one click, and long-press operation (long-press refers to long-press the touch screen for a period of time exceeding a predefined time threshold).

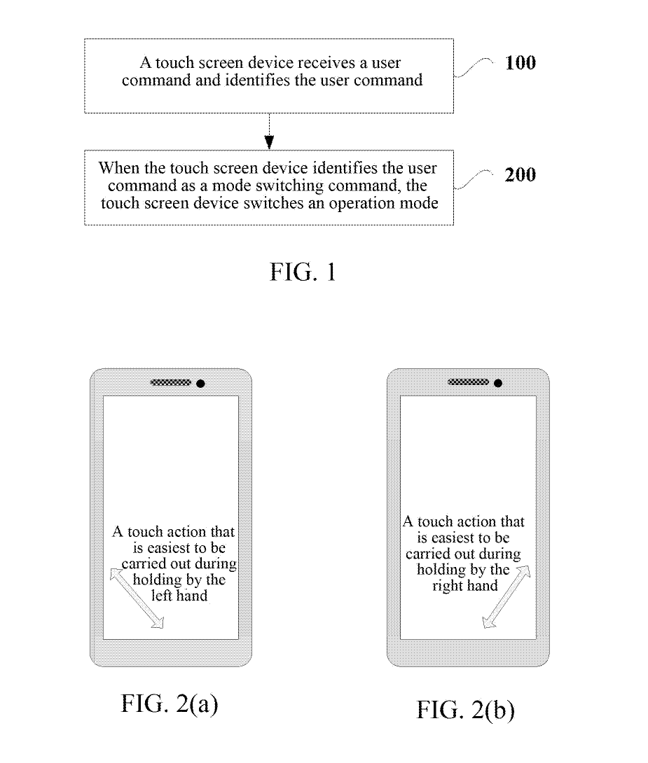

FIG. 2 shows an example of a predefined sliding track. When the mobile phone is held by the left hand, it is easy for the left hand to carry out oblique sliding from the upper left to the lower right, so the sliding from the upper left to the lower right may be set as the predefined sliding track, as shown in FIG. 2(a). When receiving a sliding input with the track, the touch screen device may prepare to perform the operation mode switching. Similarly, when the mobile phone is held by the right hand, it is easy for the right hand to carry out oblique sliding from the upper right to the lower left, so the sliding from the upper right to the lower left may be set as the predefined sliding track, as shown in FIG. 2(b). When receiving a sliding input with the track, the touch screen device may prepare to perform the operation mode switching.

The touch operation with the set sliding track may be carried out in other ways. For example, drawing a broken line on the screen; when the mobile phone is held by the left hand, a broken line sliding towards the right and then downwards may be used for triggering the operation mode switching; when the mobile phone is held by the right hand, a broken line sliding towards the left and then downwards may be used for triggering the operation mode switching. Or, another example is performing touch sliding in a circle on the screen, to trigger the operation mode switching.

Another example of setting a touch command is clicking continuously. For example, continuously clicking the touch screen twice or three times, is carried out to start the operation mode switching.

Another example of setting a touch command is long-press, for example, long-press the touch screen. Long-press means long-press the screen for a certain period of time, and the certain period of time may have a preset judgment threshold.

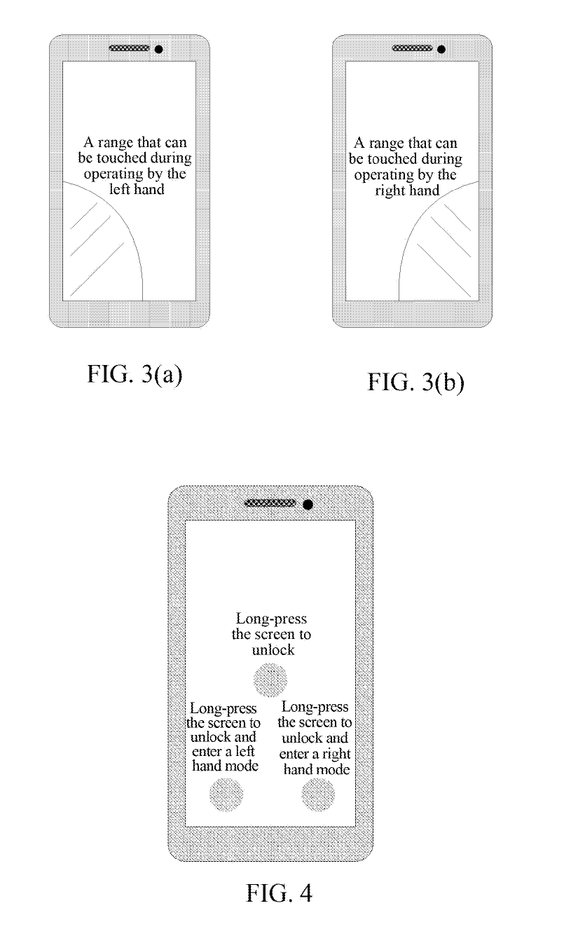

In addition, an operation area of the specific touch command on the touch screen may be limited, that is, the touch operation command is a touch operation command for setting a screen area. For example, as shown in FIG. 3, when the touch screen mobile phone is held by the left hand or the right hand, the areas that the left hand and the right hand can touch are shown in FIG. 3(a) and FIG. 3(b) respectively. So the operation area of the specific touch command (namely the mode switching command) on the touch screen may be limited as the area limited by the arc in FIG. 3. Only when the user performs the specific touch operation in the limited area, can the operation mode switching be started; in other words, the touch screen device only needs to receive and identify the specific touch operation in the limited area.

Or more generally, the set touch area may also be defined in other ways, like the left side and the right side of the touch screen, or an area defined by the user through the interface for setting, or an area for receiving the specific touch command that is displayed on the screen.

Note that, in the step 200, after the touch screen device identifies the user command as the mode switching command, there can be various ways of switching the operation mode.

For example, the operation mode switching may be a way of cycling, for example, cycling in a sequence ‘left hand-right hand-normal (usual)’; when the operation command of mode switching is identified in the normal mode, the operation mode is switched to the left hand mode; when the operation command of mode switching is identified in the left hand mode, the operation mode is switched to the right hand mode; similarly, when the operation command is identified in the right hand mode, the operation mode is switched to the normal mode. That is, through the solution, when the touch screen device identifies the user command as the mode switching command, it is only needed to directly switch to the next operation mode of the current operation mode.

For another example, the operation command distinguishes the command input by the left hand and the command input by the right hand (the left diagram and the right diagram in FIG. 2 represent the command input by the left hand and the command input by the right hand respectively). When the command input by the left hand is identified, if the current mode is the left hand mode, it is to exit from the left hand mode; if the current mode is not the left hand mode, it is to enter the left hand mode. When exiting from the left hand mode, it is possible to exit to the mode before entering the left hand mode (for example, if it is the normal mode or the right hand mode before entering the left hand mode, it is to exit to the normal mode or the right hand mode), or exit to the normal mode. If the current mode is the right hand mode, the way of exiting from the right hand mode is similar. That is, through the solution, when the touch screen device identifies the user command as the mode switching command, it is only needed to switch the current mode to the operation mode specifically indicated by the user command.

For another example, when the mode switching operation command is identified, a dialogue box may is pop-up on the screen to inquire whether to perform the operation mode switching. When ‘yes’ is selected, the operation mode switching is performed, to avoid misoperation. Through the solution, when the touch screen device identifies the user command as the mode switching command, it is only needed to switch the current operation mode to the operation mode selected by the user.

In addition, the operation mode switching may be implemented on any interface, for example, a desktop interface and a lock screen interface of the mobile phone, and other application interfaces, such as an address book interface, and a keyboard or handwriting input interface and the like.

For example, on the lock screen interface, the mode switching command may also be used for unlocking. That is, when the user command is identified as the mode switching command, it is to unlock the screen while performing the operation mode switching; for example, the voice command may be used for unlocking and mode switching.

Or, multiple unlocking operation areas are set on the lock screen interface; when the unlocking operation is detected in different unlocking areas, it is to enter the corresponding operation mode while unlocking. By taking long-press the screen to unlock as an example, the lock screen interface that is suitable for the operation mode switching is shown in FIG. 4.

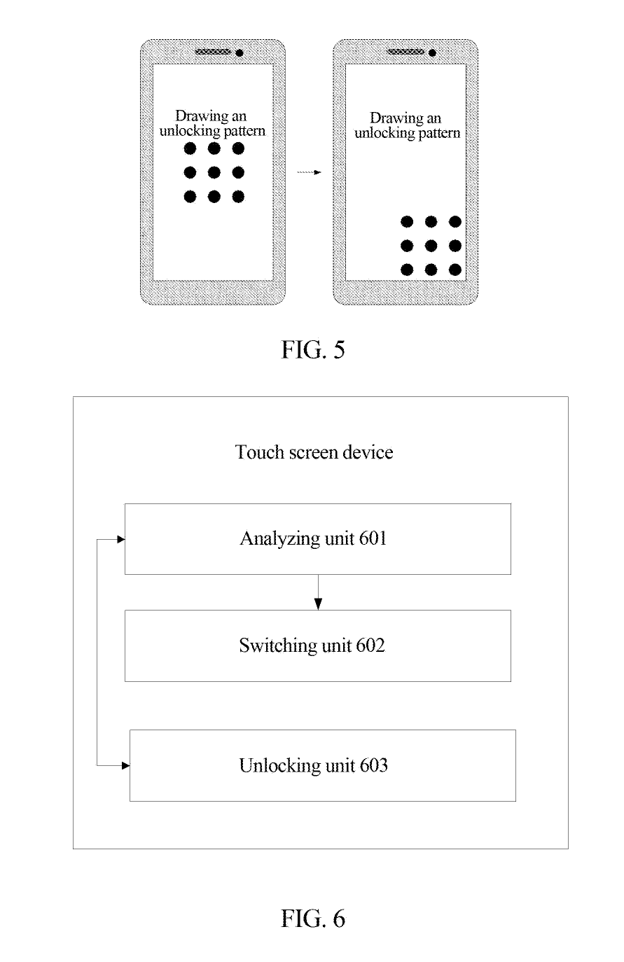

On the lock screen interface with an unlocking password, when the mode switching command is identified, the display position of an unlocking and inputting area may be adjusted to be convenient for the user to input; after the user inputs the password, the operation mode switching is performed. For example, on a character password unlocking or pattern password unlocking interface, when the operation mode switching command is identified, for example, when the switching command for switching to the right hand operation mode is identified, the corresponding character input keyboard or the pattern unlocking area slides to the lower right corner to be displayed, so that the user can input by the right hand. As shown in FIG. 5, after the unlocking is successful, the right hand operation mode is entered.

The other unlocking ways are similar, that is, on the interface requiring unlocking the touch screen, after the operation mode switching command is detected, first the corresponding touch operation area moves to the operation area that is convenient for operation in the corresponding operation mode. For example, when it is detected that the operation mode switching command is used for switching to the right hand operation mode, the corresponding unlocking touch operation area moves to the area that is convenient for the right hand to operate, such as, the lower right corner.

### Embodiment Two

The present embodiment provides a touch screen device. Through a predefined or user-defined operation command, the operation mode switching of the touch screen device may be achieved by a single hand, thereby improving the user experience of a touch screen device, especially a device with a large screen.

Specifically, the touch screen device provided by the present embodiment at least includes the following two units (an analyzing unit 601 and a switching unit 602).

The analyzing unit 601 is configured to receive the user command, and identify the user command.

Herein, the mode switching command includes the set touch operation command and the set voice operation command.

In an exemplary embodiment, the set touch operation command may be a touch operation command for setting a touch action, a touch operation command for setting a screen area, or a touch operation command for setting a touch action in a set screen area.

The switching unit 602 is configured to, when the touch screen device identifies the user command as the mode switching command, perform the operation mode switching.

Herein, the operation mode is the left hand operation mode, the right hand operation mode or the normal mode.

In practical applications, the switching unit may perform the operation mode switching in various switching ways.

For example, the switching unit 602 switches to the next operation mode of the current operation mode; or

the current operation mode is switched to the operation mode indicated by the user command; or

the current operation mode is switched to the operation mode selected by the user.

In addition, in some other solutions, an unlocking unit 603 is added. The unlocking unit may unlock the touch screen after the analyzing unit receives the user command and before the analyzing unit identifies the user command.

Since the device may implement the solution of the embodiment one, other detailed operations of the device may refer to the corresponding content of the embodiment one, and will not be elaborated here.

The present disclosure further discloses a terminal, including any above touch screen device.

The present disclosure further discloses a computer program, including a program command; when the program command is executed by the terminal, the terminal can perform any above method for operating a touch screen device.

The present disclosure further discloses a carrier, carrying the computer program.

Those ordinary skilled in the art may understand that all or part of the steps in the method can be performed by related hardware instructed through a program; the program may be stored in computer readable storage media, such as a read-only memory, a magnetic disk or a compact disk or the like. In an exemplary embodiment, all or part of the steps of the embodiment may also be implemented by using one or multiple integrated circuits. Correspondingly, each module/unit in the embodiments may be implemented in the form of hardware or in the form of software function module. The present disclosure is not limited to any particular combination of hardware and software.

The above is only the alternative embodiments of the present disclosure and not intended to limit the present disclosure. Any modifications, equivalent replacements, improvements and the like within the rule and principle of the present disclosure shall fall within the scope of protection of the present disclosure.

### INDUSTRIAL APPLICABILITY

According to the technical solutions of the present disclosure, through a predefined or user-defined operation command, the operation mode switching of a touch screen device may be achieved by a single hand, so the key problem of single-handed operation of a touch screen device with a large screen is solved and the single-handed operation can be really achieved, thereby greatly improving the user experience of a touch screen device with a large screen. Therefore, the present disclosure has strong industrial applicability.

What is claimed is:

1. A method for operating a touch screen device, comprising:
receiving, by the touch screen device, a user command, and identifying the user command;
switching, by the touch screen device, an operation mode when the touch screen device identifies the user command as a mode switching command;
wherein, the operation mode comprises a left hand operation mode, a right hand operation mode or a normal mode.

2. The method for operating a touch screen device according to claim 1, wherein the mode switching command comprises a set touch operation command and a set voice operation command.

3. The method for operating a touch screen device according to claim 2, wherein the set touch operation command comprises:
a touch operation command for setting a touch action, a touch operation command for setting a screen area, or a touch operation command for setting a touch action in a set screen area.

4. The method for operating a touch screen device according to claims 1, wherein the step of switching, by the touch screen device, an operation mode when the touch screen device identifies the user command as a mode switching command, comprises:
when the touch screen device identifies the user command as the mode switching command, switching to a next operation mode of a current operation mode; or
when the touch screen device identifies the user command as the mode switching command, switching the current operation mode to an operation mode indicated by the user command; or,
when the touch screen device identifies the user command as the mode switching command, switching the current operation mode to an operation mode selected by a user.

5. The method for operating a touch screen device according to claim 4, wherein after the step of receiving, by the touch screen device, the user command, and before the step of identifying the user command, the method further comprises:
unlocking the touch screen.

6. A touch screen device, comprising an analyzing unit and a switching unit, wherein,
the analyzing unit is configured to receive a user command, and identify the user command;
the switching unit is configured to, when the analyzing unit identifies the user command as a mode switching command, switch an operation mode;
wherein, the operation mode is a left hand operation mode, a right hand operation mode or a normal mode.

7. The touch screen device according to claim 6, wherein the mode switching command comprises a set touch operation command and a set voice operation command.

8. The touch screen device according to claim 7, wherein,
the set touch operation command comprises: a touch operation command for setting a touch action, a touch operation command for setting a screen area, or a touch operation command for setting a touch action in a set screen area.

9. The touch screen device according to claim 6, wherein the switching unit is configured to switch the operation mode in the following way:
switching to a next operation mode of a current operation mode; or
switching the current operation mode to an operation mode indicated by the user command; or,
switching the current operation mode to an operation mode selected by a user.

10. The touch screen device according to claim 9, further comprising an unlocking unit; wherein,
the unlocking unit is configured to, after the analyzing unit receives the user command, unlock the touch screen, and after unlocking is completed, inform the analyzing unit to identify the user command.

11. A terminal, comprising the touch screen device according to claim 6.

12. A computer program, comprising a program command; wherein, when the program command is executed by a terminal, the terminal can perform the method for operating a touch screen device according to claim 1.

13. A carrier, carrying the computer program according to claim 12.

14. The method for operating a touch screen device according to claim 2, wherein the step of switching, by the touch screen device, an operation mode when the touch screen device identifies the user command as a mode switching command, comprises:
when the touch screen device identifies the user command as the mode switching command, switching to a next operation mode of a current operation mode; or
when the touch screen device identifies the user command as the mode switching command, switching the current operation mode to an operation mode indicated by the user command; or,
when the touch screen device identifies the user command as the mode switching command, switching the current operation mode to an operation mode selected by a user.

15. The method for operating a touch screen device according to claim 3, wherein the step of switching, by the touch screen device, an operation mode when the touch screen device identifies the user command as a mode switching command, comprises:
when the touch screen device identifies the user command as the mode switching command, switching to a next operation mode of a current operation mode; or
when the touch screen device identifies the user command as the mode switching command, switching the current operation mode to an operation mode indicated by the user command; or,
when the touch screen device identifies the user command as the mode switching command, switching the current operation mode to an operation mode selected by a user.

16. The touch screen device according to claim 7, wherein the switching unit is configured to switch the operation mode in the following way:
switching to a next operation mode of a current operation mode; or
switching the current operation mode to an operation mode indicated by the user command; or,
switching the current operation mode to an operation mode selected by a user.

17. The touch screen device according to claim 8, wherein the switching unit is configured to switch the operation mode in the following way:
switching to a next operation mode of a current operation mode; or
switching the current operation mode to an operation mode indicated by the user command; or,
switching the current operation mode to an operation mode selected by a user.
